(19) United States
(12) Patent Application Publication
(10) Pub. No.: US 2024/0078114 A1
(43) Pub. Date: Mar. 7, 2024

(54) PROVIDING MEMORY PREFETCH INSTRUCTIONS WITH COMPLETION NOTIFICATIONS IN PROCESSOR-BASED DEVICES

(71) Applicant: Microsoft Technology Licensing, LLC, Redmond, WA (US)

(72) Inventors: Thomas Philip SPEIER, Wake Forest, NC (US); Maoni Z. STEPHENS, Kirkland, WA (US)

(21) Appl. No.: 17/939,518

(22) Filed: Sep. 7, 2022

(51) Int. Cl. G06F 9/38; G06F 12/0811; G06F 12/0875

(52) U.S. Cl. CPC G06F 9/3808; G06F 12/0811; G06F 12/0875; G06F 2212/452

(57) ABSTRACT

Providing memory prefetch instructions with completion notifications in processor-based devices is disclosed. In this regard, an instruction set architecture (ISA) of a processor-based device provides a memory prefetch instruction that, when executed by a processor of a processor-based device, causes the processor to perform a memory prefetch operation by asynchronously retrieving a memory block from the system memory based on the memory address, and storing the memory block in a cache memory of the processor-based device. In response to completing the memory prefetch operation, the processor then notifies an executing software process that the memory prefetch operation is complete. Based on the notification, the executing software process may ensure that any subsequent memory access requests are not attempted until the memory prefetch operation is complete.

### FIELD OF THE DISCLOSURE

The technology of the disclosure relates to memory access in processor-based devices and, more particularly, to optimizing performance by prefetching data from system memory to caches.

### BACKGROUND

Instruction set architectures (ISAs) on which processor-based devices are implemented are fundamentally oriented around the use of memory, with memory store instructions provided by an ISA to write data to a system memory and memory load instructions provided by the ISA to read data back from the system memory. Processor-based devices are subject to a phenomenon known as memory latency, which is a time interval between a processor initiating a memory access request (i.e., by executing a memory load instruction) for data and the processor actually receiving the requested data. In more extreme cases, memory latency for a memory access request may be large enough that the processor is forced to stall further execution of instructions while waiting for a memory access request to be fulfilled. For this reason, memory latency is considered to be one of the factors having the biggest impact on the performance of modern processor-based devices.

A number of approaches, both hardware-based and software-based, have been developed to minimize or hide the effects of memory latency. One approach involves the use of larger caches to move and store greater amounts of frequently-accessed data closer to processors. Another approach uses hardware-based prefetcher circuits to detect memory access patterns and preemptively retrieve and store data in caches prior to memory access demands for the data. Software-executed memory prefetch instructions may also be used to request a prefetch of data by hardware into a cache memory prior to an upcoming memory access request by the software. In particular, software-executed memory prefetch instructions are an attractive option because software can more readily determine which memory locations are likely to be accessed in the future.

However, one shortcoming of the use of software-executed memory prefetch instructions is that software may have difficulty in accurately predicting how far in advance of a memory access request to execute a memory prefetch instruction. If the memory prefetch instruction is executed too close in time before the memory access request, the requested data may not have been retrieved and stored in a cache memory when the memory access request is executed. Conversely, if the memory prefetch instruction is executed too far in time before the memory access request, the requested data may be successfully retrieved and stored in a cache memory, but the cache line storing the requested data may be subsequently displaced from the cache memory before the memory access request is executed. Moreover, the different memory latencies of different processor microarchitectures may require software to employ prefetching algorithms that are specific to each microarchitecture.

Accordingly, a more efficient mechanism for providing software-executed memory prefetch instructions is desirable.

### SUMMARY

Exemplary embodiments disclosed herein include providing memory prefetch instructions with completion notifications in processor-based devices. In this regard, in one exemplary embodiment, an instruction set architecture (ISA), on which a processor-based device is implemented, provides a memory prefetch instruction that, when executed, causes a processor of the processor-based device to perform a memory prefetch operation. The processor performs the memory prefetch operation asynchronously so that an executing software process (of which the memory prefetch instruction is a part) may continue performing other operations while the memory prefetch operation is carried out. When the requested data has been retrieved and stored in a cache memory, the processor notifies the executing software process that the memory prefetch operation is complete. In some exemplary embodiments, the processor may notify the executing software process that the memory prefetch operation is complete by writing a completion indication to a general-purpose register or a special-purpose register of the processor, by raising an interrupt, and/or by redirecting program control of the executing software process to a specified target address. Upon receiving the notification (e.g., by reading a completion indication from the general-purpose register or special-purpose register, by executing an interrupt handler in response to the raised interrupt, or by executing a callback function at the target address), the executing software process can ensure that any subsequent memory access requests to the same memory address as the memory prefetch operation are not attempted until the memory prefetch operation is complete.

Some exemplary embodiments may provide that the memory prefetch instruction may comprise, specify, or otherwise be associated with an indication of a cache level (e.g., an indication of one of a Level 1 (L1) cache, a Level 2 (L2) cache, or a Level 3 (L3) cache) into which a requested memory block is to be prefetched. According to some exemplary embodiments, the processor may prefetch a plurality of memory blocks and may notify the executing software process for each memory block of the plurality of memory blocks (e.g., by providing a separate notification for each memory block). In some exemplary embodiments, the memory prefetch instruction may comprise a custom opcode, while some exemplary embodiments may provide that the memory prefetch instruction comprises an existing opcode and a custom prefetch completion request indicator (e.g., a bit indicator).

In another exemplary embodiment, a processor-based device is provided. The processor-based device comprises a system memory, a processor that includes an execution pipeline, and a cache memory external to the system memory. The processor is configured to receive, using the execution pipeline of the processor, a memory prefetch instruction of an executing software process, wherein the memory prefetch instruction is associated with a memory address. The processor is further configured to perform a memory prefetch operation by being configured to asynchronously retrieve a memory block from the system memory based on the memory address, and store the memory block in the cache memory. The processor is also configured to, responsive to completing the memory prefetch operation, notify the executing software process that the memory prefetch operation is complete.

In another exemplary embodiment, a method for providing memory prefetch instructions with completion notifications in processor-based devices is provided. The method comprises receiving, using an execution pipeline of a processor of a processor-based device, a memory prefetch instruction of an executing software process, wherein the memory prefetch instruction is associated with a memory address. The method further comprises performing a memory prefetch operation by asynchronously retrieving a memory block from a system memory of the processor-based device based on the memory address, and storing the memory block in a cache memory of the processor-based device. The method also comprises, responsive to completing the memory prefetch operation, notifying the executing software process that the memory prefetch operation is complete.

In another exemplary embodiment, a non-transitory computer-readable medium is provided. The computer-readable memory stores thereon an instruction program comprising a plurality of computer executable instructions for execution by a processor of a processor-based device, the plurality of computer executable instructions comprising a memory prefetch instruction. The memory prefetch instruction, when executed by the processor, causes the processor to perform a memory prefetch operation by causing the processor to asynchronously retrieve a memory block from a system memory of a processor-based device based on a memory address associated with the memory prefetch instruction, and store the memory block in a cache memory. The memory prefetch instruction further causes the processor to, responsive to completing the memory prefetch operation, notify an executing software process that the memory prefetch operation is complete.

Those skilled in the art will appreciate the scope of the present disclosure and realize additional embodiments thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several embodiments of the disclosure, and together with the description serve to explain the principles of the disclosure.

FIG. 1 is a block diagram of an exemplary processor-based device that includes a processor for providing memory prefetch instructions with completion notifications, according to some exemplary embodiments;

FIGS. 2A and 2B are block diagrams illustrating exemplary memory prefetch instructions corresponding to the memory prefetch instruction of FIG. 1 for providing completion notifications, according to some exemplary embodiments;

FIGS. 3A and 3B are flowcharts illustrating exemplary operations for providing memory prefetch instructions with completion notifications by the processor-based device of FIG. 1; and

FIG. 4 is a block diagram of an exemplary processor-based device, such as the processor-based device of FIG. 1, that is configured to provide memory prefetch instructions with completion notifications, according to some exemplary embodiments.

### DETAILED DESCRIPTION

Exemplary embodiments disclosed herein include providing memory prefetch instructions with completion notifications in processor-based devices. In this regard, in one exemplary embodiment, an instruction set architecture (ISA), on which a processor-based device is implemented, provides a memory prefetch instruction that, when executed, causes a processor of the processor-based device to perform a memory prefetch operation. The processor performs the memory prefetch operation asynchronously so that an executing software process (of which the memory prefetch instruction is a part) may continue performing other operations while the memory prefetch operation is carried out. When the requested data has been retrieved and stored in a cache memory, the processor notifies the executing software process that the memory prefetch operation is complete. In some exemplary embodiments, the processor may notify the executing software process that the memory prefetch operation is complete by writing a completion indication to a general-purpose register or a special-purpose register of the processor, by raising an interrupt, and/or by redirecting program control of the executing software process to a specified target address. Upon receiving the notification (e.g., by reading a completion indication from the general-purpose register or special-purpose register, by executing an interrupt handler in response to the raised interrupt, or by executing a callback function at the target address), the executing software process can ensure that any subsequent memory access requests to the same memory address as the memory prefetch operation are not attempted until the memory prefetch operation is complete.

Some exemplary embodiments may provide that the memory prefetch instruction may comprise, specify, or otherwise be associated with an indication of a cache level (e.g., an indication of one of a Level 1 (L1) cache, a Level 2 (L2) cache, or a Level 3 (L3) cache) into which a requested memory block is to be prefetched. According to some exemplary embodiments, the processor may prefetch a plurality of memory blocks and may notify the executing software process for each memory block of the plurality of memory blocks (e.g., by providing a separate notification for each memory block). In some exemplary embodiments, the memory prefetch instruction may comprise a custom opcode, while some exemplary embodiments may provide that the memory prefetch instruction comprises an existing opcode and a custom prefetch completion request indicator (e.g., a bit indicator).

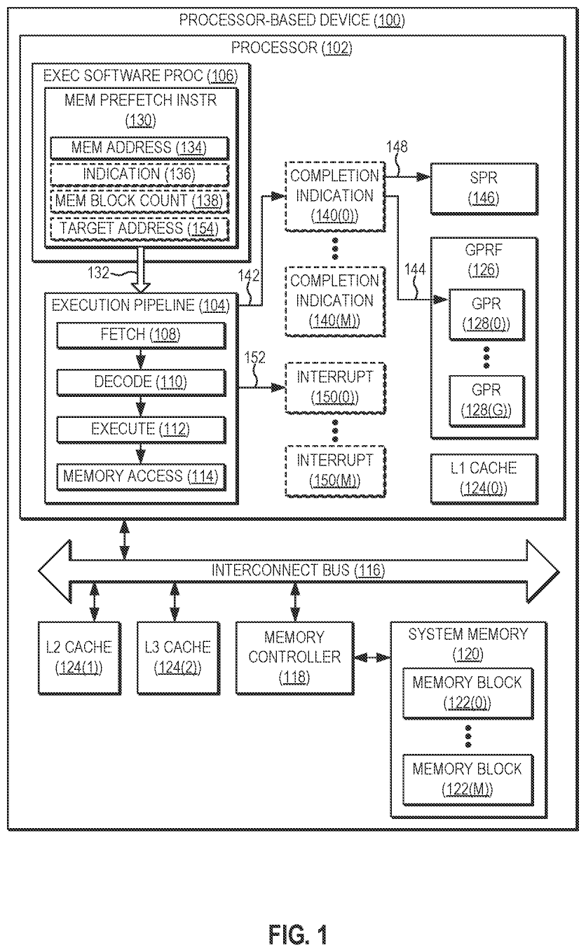

In this regard, FIG. 1 illustrates an exemplary processor-based device 100 that provides a processor 102 for providing memory prefetch instructions with completion notifications. The processor 102 may comprise a central processing unit (CPU) having one or more processor cores, and in some exemplary embodiments may be one of a plurality of similarly configured processors (not shown) of the processor-based device 100. The processor 102 of FIG. 1 includes an execution pipeline 104 that comprises circuitry configured to execute an instruction stream of computer-executable instructions of an executing software process (captioned as “EXEC SOFTWARE PROC” in FIG. 1) 106. In the example of FIG. 1, the execution pipeline 104 includes a fetch stage (captioned as “FETCH” in FIG. 1) 108 for retrieving instructions for execution, a decode stage (captioned as “DECODE” in FIG. 1) 110 for translating fetched instructions into control signals for instruction execution, an execute stage (captioned as “EXECUTE” in FIG. 1) 112 for actually performing instruction execution, and a memory access stage (captioned as “MEMORY ACCESS” in FIG. 1) 114 for carrying out memory access operations (e.g., memory load operations and/or memory store operations) resulting from instruction execution. It is to be understood that, in some embodiments, the execution pipeline 104 may include fewer or more stages than those illustrated in the example of FIG. 1.

In the example of FIG. 1, the processor 102 is communicatively coupled to an interconnect bus 116, which in some embodiments may include additional constituent elements (e.g., a bus controller circuit and/or an arbitration circuit, as non-limiting examples) that are not shown in FIG. 1 for the sake of clarity. The processor 102 is also communicatively coupled, via the interconnect bus 116, to a memory controller 118 that controls access to a system memory 120 and manages the flow of data to and from the system memory 120. The system memory 120 provides addressable memory used for data storage by the processor-based device 100, and as such may comprise synchronous dynamic random access memory (SDRAM), as a non-limiting example. The system memory 120 is subdivided into a plurality of memory blocks including memory blocks 122(0)-122(M). The size of each of the memory blocks 122(0)-122(M) may correspond to a system cache line size as determined by an underlying architecture of the processor 102.

The processor 102 of FIG. 1 further includes a Level 1 (L1) cache memory 124(0) that may be used to cache local copies of frequently accessed data within the processor 102 for quicker access by the memory access stage 114 of the execution pipeline 104. The processor 102 in the example of FIG. 1 is also communicatively coupled, via the interconnect bus 116, to a Level 2 (L2) cache memory 124(1) and a Level 3 (L3) cache memory 124(2). The L1 cache memory 124(0), the L2 cache memory 124(1), and the L3 cache memory 124(2) together make up a hierarchical cache structure used by the processor-based device 100 to cache frequently accessed data for faster retrieval (compared to retrieving data from the system memory 120). The L1 cache memory 124(0), the L2 cache memory 124(1), and the L3 cache memory 124(2) are collectively referred to herein as “cache memory 124.”

In the example of FIG. 1, the processor 102 also includes a general-purpose register file (captioned as “GPRF” in FIG. 1) 126 that provides multiple general-purpose registers (captioned as “GPR” in FIG. 1) 128(0)-128(G) for use by hardware and software for storing data such as operands upon which arithmetic and logical operations may be performed. In conventional operation, the execute stage 112 of the execution pipeline 104 may access the general-purpose register file 126 to retrieve operands from and/or store results of arithmetic or logical operations to one of the general-purpose registers 128(0)-128(G).

The processor-based device 100 of FIG. 1 may encompass any one of known digital logic elements, semiconductor circuits, processing cores, and/or memory structures, among other elements, or combinations thereof. Embodiments described herein are not restricted to any particular arrangement of elements, and the disclosed techniques may be easily extended to various structures and layouts on semiconductor sockets or packages. It is to be understood that some embodiments of the processor-based device 100 may include more or fewer elements than illustrated in FIG. 1. For example, the processor 102 may further include more or fewer memory devices execution pipeline stages, controller circuits, buffers, and/or caches.

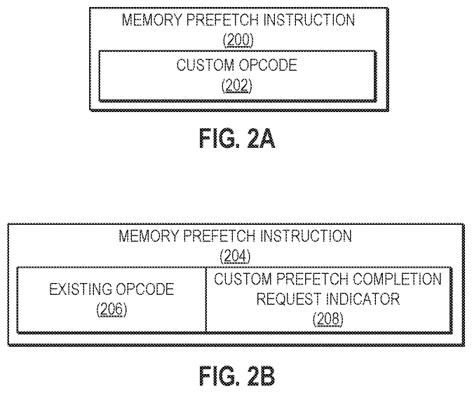

As discussed above, while software-executed memory prefetch instructions are often an attractive option because software can more readily determine which memory locations are likely to be accessed in the future, software may have difficulty in accurately predicting how far in advance of a memory access request to execute a memory prefetch instruction. In this regard, the ISA of the processor-based device 100 of FIG. 1 provides a memory prefetch instruction (captioned as “MEM PREFETCH INSTR” in FIG. 1) 130. The memory prefetch instruction 130 is included as part of the instructions (not shown) making up the executing software process 106. As discussed below in greater detail with respect to FIGS. 2A and 2B, the memory prefetch instruction 130 may comprise a custom opcode provided by the ISA of the processor-based device 100, or may comprise an existing opcode and a custom prefetch completion request indicator (not shown).

In exemplary operation, during execution of the executing software process 106, the execution pipeline 104 of the processor 102 receives the memory prefetch instruction 130 in conventional fashion, as indicated by arrow 132. The memory prefetch instruction 130 comprises, specifies, or otherwise is associated with a memory address (captioned as “MEM ADDRESS” in FIG. 1) 134 that indicates a location within the system memory 120 from which a memory block, such as the memory blocks 122(0)-122(M), will be retrieved and copied into the cache memory 124 (i.e., the L1 cache memory 124(0), the L2 cache memory 124(1), or the L3 cache memory 124(2) of FIG. 1).

Upon execution of the memory prefetch instruction 130 by the execution pipeline 104, the processor 102 performs a memory prefetch operation by asynchronously retrieving one or more memory blocks 122(0)-122(M) from the system memory 120 and storing the retrieved one or more memory blocks 122(0)-122(M) in the cache memory 124. In some exemplary embodiments, the memory prefetch instruction 130 comprises, specifies, or is otherwise associated with an indication 136 of a cache level (i.e., an indication of one of the L1 cache memory 124(0), the L2 cache memory 124(1), and the L3 cache memory 124(2) of FIG. 1). In such exemplary embodiments, the retrieved one or more memory blocks 122(0)-122(M) is stored in the cache memory 124 corresponding to the indication 136 of the cache level. Some exemplary embodiments may provide that the memory prefetch instruction 130 causes a plurality of memory blocks 122(0)-122(M) to be prefetched. In some such exemplary embodiments, the processor 102 may be configured to prefetch a fixed number of memory blocks, while some such exemplary embodiments may provide that the memory prefetch instruction 130 comprises, specifies, or is otherwise associated with a memory block count (captioned as “MEM BLOCK COUNT” in FIG. 1) 138 that indicates a number of the memory blocks 122(0)-122(M) to prefetch, starting at the memory address 134.

Upon completing the memory prefetch operation, the processor 102 is configured to notify the executing software process 106. According to some exemplary embodiments, notification of prefetch completion to the executing software process 106 may be accomplished by the processor 102 writing a completion indication 140(0) to a general-purpose register such as the general-purpose register 128(0), as indicated by arrows 142 and 144. Some exemplary embodiments may provide that the processor 102 may write the completion indication 140(0) to a special-purpose register (captioned as “SPR” in FIG. 1) 146 that is implemented by the processor 102 specifically for the purpose of prefetch notification, as indicated by arrows 142 and 148. In exemplary embodiments in which a plurality of memory blocks 122(0)-122(M) are prefetched, the processor 102 may write a plurality of corresponding completion indication 140(0)-140(M) (e.g., to the general-purpose registers 128(0)-128(G) or to multiple SPRs not shown in FIG. 1) to notify the executing software process 106 as prefetching of each of the memory blocks 122(0)-122(M) is completed.

Some exemplary embodiments may provide notification of prefetch completion to the executing software process 106 by the processor 102 raising an interrupt 150(0)), as indicated by arrow 152. The executing software process 106 in such exemplary embodiments may provide an interrupt handler that is executed in response to the interrupt 150(0). In exemplary embodiments in which a plurality of memory blocks 122(0)-122(M) are prefetched, the processor 102 may raise a plurality of interrupts 150(0)-150(M), or may raise the interrupt 150(0) multiple times, to notify the executing software process 106 as prefetching of each of the memory blocks 122(0)-122(M) is completed. Some exemplary embodiments may provide that the memory prefetch instruction 130 may comprise, specify, or otherwise be associated with a target address 154 of a callback function (not shown) to be executed upon completion of the memory prefetch operation. In such exemplary embodiments, the processor 102, in response to completing the prefetch operation, may redirect program control of the executing software process 106 to the target address 154.

To illustrate exemplary memory prefetch instructions corresponding to the memory prefetch instruction 130 of FIG. 1, FIGS. 2A and 2B are provided. FIG. 2A illustrates a memory prefetch instruction 200 corresponding in functionality to the memory prefetch instruction 130 of FIG. 1. In the example of FIG. 2A, the memory prefetch instruction 200 comprises a custom opcode 202 (i.e., an opcode specifically provided by an underlying ISA for use in expressly providing a notification of memory prefetch operation completion). In contrast, FIG. 2B illustrates a memory prefetch instruction 204 that comprises an existing opcode 206 and a custom prefetch completion request indicator 208. The existing opcode 206 corresponds to an opcode provided by the ISA for a conventional memory prefetch instruction or a conventional memory load operation, while the custom prefetch completion request indicator 208 comprises an additional indicator (e.g., a bit indicator) that may be set to indicate that an executing software process (of which the memory prefetch instruction 204 is a part) is requesting a notification upon completion of the memory prefetch operation.

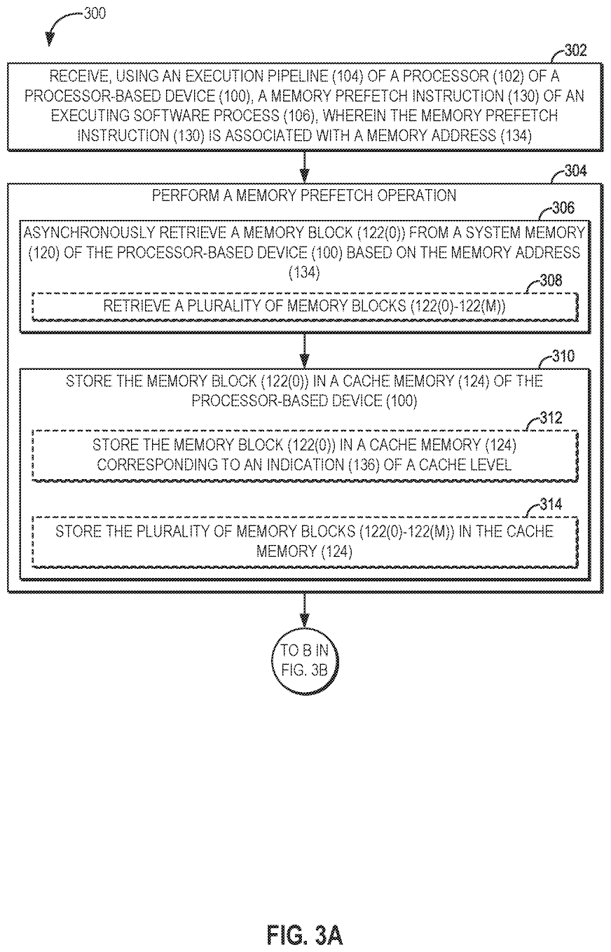

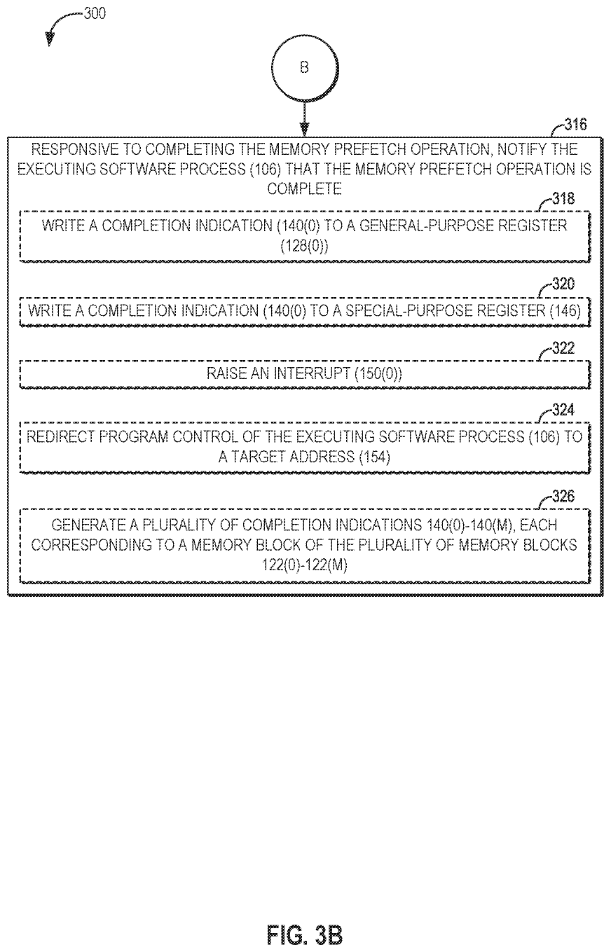

FIGS. 3A and 3B illustrate exemplary operations 300 for providing memory prefetch instructions with completion notifications by the processor-based device 100 of FIG. 1. For the sake of clarity, elements of FIG. 1 are referenced in describing FIGS. 3A and 3B. The operations 300 in FIG. 3A, according to some embodiments, begin with the execution pipeline 104 of the processor 102 of the processor-based device 100 receiving a memory prefetch instruction (e.g., the memory prefetch instruction 130 of FIG. 1) of an executing software process (e.g., the executing software process 106 of FIG. 1), wherein the memory prefetch instruction 130 is associated with a memory address, such as the memory address 134 of FIG. 1 (block 302). The processor 102 then performs a memory prefetch operation (block 304).

The operations of block 304 for performing the memory prefetch operation comprise the processor 102 asynchronously retrieving a memory block (e.g., the memory block 122(0) of FIG. 1) from a system memory (e.g., the system memory 120 of FIG. 1) of the processor-based device 100 based on the memory address 134 (block 306). In some exemplary embodiments, the operations of block 306 for retrieving the memory block may comprise retrieving a plurality of memory blocks, such as the memory blocks 122(0)-122(M) of FIG. 1 (block 308).

The processor 102 then stores the memory block 122(0) (or the memory blocks 122(0)-122(M), in some exemplary embodiments) in a cache memory (e.g., the cache memory 124 of FIG. 1) of the processor-based device 100 (block 310). Some exemplary embodiments may provide that the operations of block 310 for storing the memory block 122(0) in the cache memory 124 may comprise storing the memory block 122(0) in the cache memory 124 corresponding to an indication of a cache level, such as the indication 136 of FIG. 1 (block 312). The indication 136 may specify, for example, that the memory block 122(0) is to be stored in the L1 cache memory 124(0), the L2 cache memory 124(1), or the L3 cache memory 124(2). According to some exemplary embodiments in which multiple memory blocks 122(0)-122(M) are retrieved, the operations of block 310 for storing the memory block 122(0) in the cache memory 124 may comprise storing the plurality of memory blocks 122(0)-122(M) in the cache memory 124 (block 314). Operations then continue at block 316 of FIG. 3B.

Referring now to FIG. 3B, in response to completing the memory prefetch operation, the processor 102 notifies the executing software process 106 that the memory prefetch operation is complete (block 316). In some exemplary embodiments, the operations of block 316 for notifying the executing software process 106 that the memory prefetch operation is complete may comprise writing a completion indication (e.g., the completion indication 140(0) of FIG. 1) to a general-purpose register, such as the general-purpose register 128(0) of FIG. 1 (block 318). Some exemplary embodiments may provide that the operations of block 316 for notifying the executing software process 106 that the memory prefetch operation is complete comprise writing the completion indication 140(0) to a special-purpose register, such as the special-purpose register 146 of FIG. 1 (block 320). According to some exemplary embodiments, the operations of block 316 for notifying the executing software process 106 that the memory prefetch operation is complete may comprise raising an interrupt, such as the interrupt 150(0) of FIG. 1 (block 322). In some exemplary embodiments, the operations of block 316 for notifying the executing software process 106 that the memory prefetch operation is complete may comprise redirecting program control of the executing software process 106 to a target address 154 (block 324). Some exemplary embodiments may provide that the operations of block 316 for notifying the executing software process 106 that the memory prefetch operation is complete comprise generating a plurality of completion indications (e.g., the completion indications 140(0)-140(M) of FIG. 1), each corresponding to a memory block of the plurality of memory blocks 122(0)-122(M) (block 326).

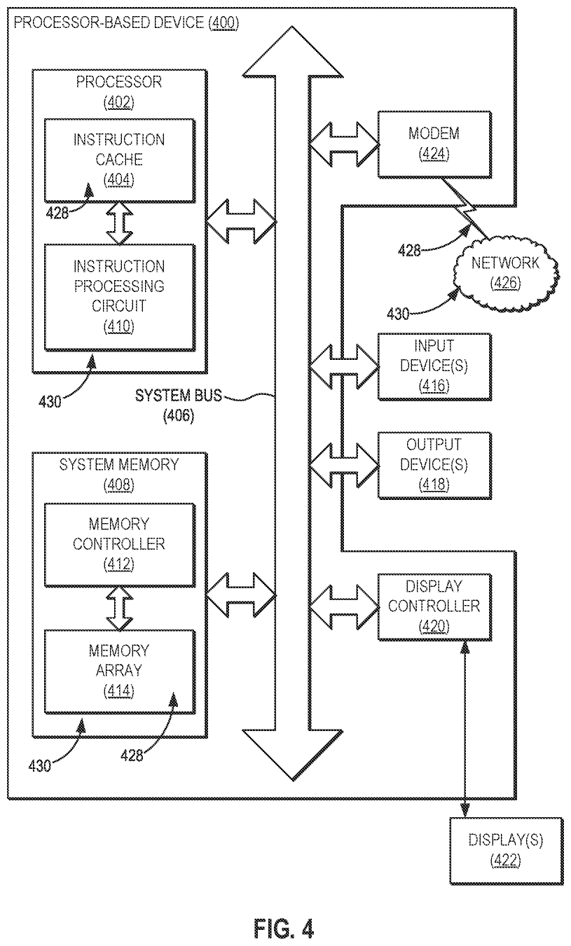

FIG. 4 is a block diagram of an exemplary processor-based device 400, such as the processor-based device 100 of FIG. 1, that provides memory prefetch instructions with completion notifications. The processor-based device 400 may be a circuit or circuits included in an electronic board card, such as, a printed circuit board (PCB), a server, a personal computer, a desktop computer, a laptop computer, a personal digital assistant (PDA), a computing pad, a mobile device, or any other device, and may represent, for example, a server or a user's computer. In this example, the processor-based device 400 includes a processor 402. The processor 402 represents one or more general-purpose processing circuits, such as a microprocessor, central processing unit, or the like, and may correspond to the processor 102 of FIG. 1. The processor 402 is configured to execute processing logic in instructions for performing the operations and steps discussed herein. In this example, the processor 402 includes an instruction cache 404 for temporary, fast access memory storage of instructions and an instruction processing circuit 410. Fetched or prefetched instructions from a memory, such as from a system memory 408 over a system bus 406, are stored in the instruction cache 404. The instruction processing circuit 410 is configured to process instructions fetched into the instruction cache 404 and process the instructions for execution.

The processor 402 and the system memory 408 are coupled to the system bus 406 (corresponding to the interconnect bus 116 of FIG. 1) and can intercouple peripheral devices included in the processor-based device 400. As is well known, the processor 402 communicates with these other devices by exchanging address, control, and data information over the system bus 406. For example, the processor 402 can communicate bus transaction requests to a memory controller 412 in the system memory 408 as an example of a peripheral device. Although not illustrated in FIG. 4, multiple system buses 406 could be provided, wherein each system bus constitutes a different fabric. In this example, the memory controller 412 is configured to provide memory access requests to a memory array 414 in the system memory 408. The memory array 414 is comprised of an array of storage bit cells for storing data. The system memory 408 may be a read-only memory (ROM), flash memory, dynamic random access memory (DRAM), such as synchronous DRAM (SDRAM), etc., and a static memory (e.g., flash memory, static random access memory (SRAM), etc.), as non-limiting examples.

Other devices can be connected to the system bus 406. As illustrated in FIG. 4, these devices can include the system memory 408, one or more input devices 416, one or more output devices 418, a modem 424, and one or more display controllers 420, as examples. The input device(s) 416 can include any type of input device, including, but not limited to, input keys, switches, voice processors, etc. The output device(s) 418 can include any type of output device, including, but not limited to, audio, video, other visual indicators, etc. The modem 424 can be any device configured to allow exchange of data to and from a network 426. The network 426 can be any type of network, including, but not limited to, a wired or wireless network, a private or public network, a local area network (LAN), a wireless local area network (WLAN), a wide area network (WAN), a BLUETOOTH™ network, and the Internet. The modem 424 can be configured to support any type of communications protocol desired. The processor 402 may also be configured to access the display controller(s) 420 over the system bus 406 to control information sent to one or more displays 422. The display(s) 422 can include any type of display, including, but not limited to, a cathode ray tube (CRT), a liquid crystal display (LCD), a plasma display, etc.

The processor-based device 400 in FIG. 4 may include a set of instructions 428 that may be encoded with the reach-based explicit consumer naming model to be executed by the processor 402 for any application desired according to the instructions. The instructions 428 may be stored in the system memory 408, processor 402, and/or instruction cache 404 as examples of non-transitory computer-readable medium 430. The instructions 428 may also reside, completely or at least partially, within the system memory 408 and/or within the processor 402 during their execution. The instructions 428 may further be transmitted or received over the network 426 via the modem 424, such that the network 426 includes the computer-readable medium 430.

While the computer-readable medium 430 is shown in an exemplary embodiment to be a single medium, the term “computer-readable medium” should be taken to include a single medium or multiple media (e.g., a centralized or distributed database, and/or associated caches and servers) that store the one or more sets of instructions 428. The term “computer-readable medium” shall also be taken to include any medium that is capable of storing, encoding, or carrying a set of instructions for execution by a processing device and that cause the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.), and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A processor-based device, comprising:
a system memory;
a processor comprising an execution pipeline; and
a cache memory external to the system memory;
the processor configured to:
receive, using the execution pipeline of the processor, a memory prefetch instruction of an executing software process, wherein the memory prefetch instruction is associated with a memory address;
perform a memory prefetch operation by being configured to:
asynchronously retrieve a memory block from the system memory based on the memory address; and
store the memory block in the cache memory; and
responsive to completing the memory prefetch operation, notify the executing software process that the memory prefetch operation is complete.

2. The processor-based device of claim 1, wherein:
the memory prefetch instruction is associated with an indication of a cache level; and
the processor is configured to store the memory block in the cache memory by being configured to store the memory block in a cache memory corresponding to the indication of the cache level.

3. The processor-based device of claim 2, wherein the indication of the cache level comprises an indication of one of a Level 1 (L1) cache, a Level 2 (L2) cache, or a Level 3 (L3) cache.

4. The processor-based device of claim 1, wherein the processor is configured to notify the executing software process that the memory prefetch operation is complete by being configured to write a completion indication to a general-purpose register.

5. The processor-based device of claim 1, wherein the processor is configured to notify the executing software process that the memory prefetch operation is complete by being configured to write a completion indication to a special-purpose register.

6. The processor-based device of claim 1, wherein the processor is configured to notify the executing software process that the memory prefetch operation is complete by being configured to raise an interrupt.

7. The processor-based device of claim 1, wherein:
the memory prefetch instruction is associated with a target address; and
the processor is configured to notify the executing software process that the memory prefetch operation is complete by being configured to redirect program control of the executing software process to the target address.

8. The processor-based device of claim 1, wherein:
the processor is configured to retrieve the memory block from the system memory based on the memory address by being configured to retrieve a plurality of memory blocks;
the processor is configured to store the memory block in the cache memory by being configured to store the plurality of memory blocks in the cache memory; and
the processor is configured to notify the executing software process that the memory prefetch operation is complete by being configured to notify the executing software process for each memory block of the plurality of memory blocks.

9. The processor-based device of claim 1, wherein the memory prefetch instruction comprises a custom opcode of an instruction set architecture (ISA) of the processor-based device.

10. A method for providing memory prefetch instructions with completion notifications in processor-based devices, the method comprising:
receiving, using an execution pipeline of a processor of a processor-based device, a memory prefetch instruction of an executing software process, wherein the memory prefetch instruction is associated with a memory address;
performing a memory prefetch operation by:
asynchronously retrieving a memory block from a system memory of the processor-based device based on the memory address; and
storing the memory block in a cache memory of the processor-based device; and
responsive to completing the memory prefetch operation, notifying the executing software process that the memory prefetch operation is complete.

11. The method of claim 10, wherein:
the memory prefetch instruction is associated with an indication of a cache level; and
storing the memory block in the cache memory comprises storing the memory block in a cache memory corresponding to the indication of the cache level.

12. The method of claim 11, wherein the indication of the cache level comprises an indication of one of a Level 1 (L1) cache, a Level 2 (L2) cache, or a Level 3 (L3) cache.

13. The method of claim 10, wherein notifying the executing software process that the memory prefetch operation is complete comprises writing a completion indication to a general-purpose register.

14. The method of claim 10, wherein notifying the executing software process that the memory prefetch operation is complete comprises writing a completion indication to a special-purpose register.

15. The method of claim 10, wherein notifying the executing software process that the memory prefetch operation is complete comprises raising an interrupt.

16. The method of claim 10, wherein:
the memory prefetch instruction is associated with a target address; and
notifying the executing software process that the memory prefetch operation is complete comprises redirecting program control of the executing software process to the target address.

17. The method of claim 10, wherein:
retrieving the memory block from the system memory based on the memory address comprises retrieving a plurality of memory blocks;
storing the memory block in the cache memory comprises storing the plurality of memory blocks in the cache memory; and
notifying the executing software process that the memory prefetch operation is complete comprises notifying the executing software process for each memory block of the plurality of memory blocks.

18. The method of claim 10, wherein the memory prefetch instruction comprises a custom opcode of an instruction set architecture (ISA) of the processor-based device.

19. A non-transitory computer-readable medium having stored thereon an instruction program comprising a plurality of computer executable instructions for execution by a processor of a processor-based device, the plurality of computer executable instructions comprising a memory prefetch instruction that, when executed by the processor, causes the processor to:
perform a memory prefetch operation by causing the processor to:
asynchronously retrieve a memory block from a system memory of a processor-based device based on a memory address associated with the memory prefetch instruction; and
store the memory block in a cache memory; and
responsive to completing the memory prefetch operation, notify an executing software process that the memory prefetch operation is complete.

20. The non-transitory computer readable medium of claim 19, wherein the memory prefetch instruction comprises a custom opcode of an instruction set architecture (ISA) of the processor-based device.
